(19) United States
(12) Patent Application Publication
(10) Pub. No.: US 2012/0266594 A1
(43) Pub. Date: Oct. 25, 2012

(54) INTERNAL COMBUSTION ENGINE

(75) Inventor: Ralf Christmann, Kaiserslautern (DE)

(73) Assignee: BORGWARNER INC., Auburn Hills, MI (US)

(21) Appl. No.: 13/515,062

(22) PCT Filed: Dec. 14, 2010
(86) PCT No.: PCT/US2010/060199

§ 371 Date: Jun. 11, 2012

(30) Foreign Application Priority Data
Dec. 22, 2009 (DE) 102009060055.8

(51) Int. Cl. F02M 25/07; F02D 9/04; F02B 37/00

(52) U.S. Cl. 60/605.2

(57) ABSTRACT

The present invention relates to an internal combustion engine (1), having an intake section (2) which has an intake line (3) in which a compressor (4) of an exhaust-gas turbocharger (5) is arranged; having an exhaust section (6) which has an exhaust line (7) in which a turbine (8) of the exhaust-gas turbocharger (5) is arranged; and having a low-pressure exhaust-gas recirculation device (9) which has an exhaust-gas recirculation line (10) which branches off from the exhaust line (7) downstream of the turbine (8) and which opens into the intake line (3) upstream of the compressor (4) and in which an exhaust-gas recirculation valve (11) is arranged. Here, a throttle device (12) is arranged in the intake line (3) upstream of the compressor (4).

### DESCRIPTION

The invention relates to an internal combustion engine according to the preamble of claim 1.

In the prior art, to reduce NOx emissions, use is made of low-pressure exhaust-gas recirculation arrangements, also in conjunction with a high-pressure exhaust-gas recirculation arrangement. In general, exhaust-gas recirculation reduces the combustion temperature, as a result of which nitrogen oxides can be reduced.

In order that the exhaust gas can flow in the direction of the compressor unit downstream of the turbine outlet, a pressure difference must be present. Said pressure difference is often generated by means of a throttle at the end of the exhaust line downstream of the branch of the exhaust-gas recirculation line. However, this increases the exhaust-gas counterpressure, which has an adverse effect on power delivery.

It is therefore an object of the present invention to provide an internal combustion engine of the type specified in the preamble of claim 1 which permits the build-up of a pressure difference between the exhaust-gas and intake lines without increasing the exhaust-gas counterpressure.

Said object is achieved by means of the features of claim 1. The subclaims relate to advantageous refinements of the invention.

According to the invention, the throttle may be a throttle flap which reduces the throughflow, as a result of which a more pronounced underpressure is generated upstream of the compressor. The reduction of the throughflow does not adversely affect the arrangement according to the invention because the highest exhaust-gas recirculation rates are used in the part-load range. The exhaust-gas recirculation quantity may, like before, be regulated by means of a separate valve, for example by means of a disk valve which has the required degree of sealing.

Further details, advantages and features of the present invention will emerge from the following description of exemplary embodiments on the basis of the drawing, in which:

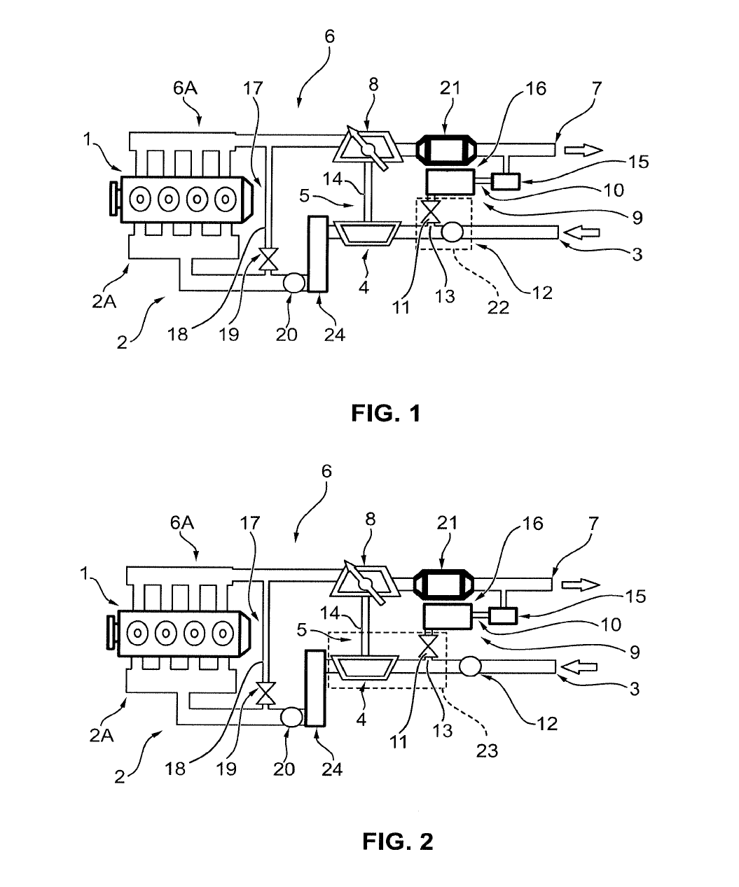

FIG. 1 shows a schematic illustration of a first embodiment of an internal combustion engine according to the invention, and

FIG. 2 shows an illustration, corresponding to FIG. 1, of a second embodiment of the internal combustion engine according to the invention.

The internal combustion engine 1 schematically illustrated in FIGS. 1 and 2 may be either a diesel engine or a spark-ignition engine.

The internal combustion engine 1 illustrated in FIG. 1 has an intake section 2 and an exhaust section 6. A compressor 4 of an exhaust-gas turbocharger 5 is arranged in the intake line 3 of the intake section 2, and a turbine 8 of an exhaust-gas turbocharger 5 is arranged in the exhaust line 7 of the exhaust section 6.

Furthermore, the internal combustion engine I comprises a low-pressure exhaust-gas recirculation device 9 which comprises an exhaust-gas recirculation line 10 which branches off from the exhaust line 7 downstream of the turbine 8 and opens into the intake line 3 upstream of the compressor 4. In the low-pressure exhaust-gas recirculation device 9, the intake line 3 has arranged in it an exhaust-gas recirculation valve 11 and, upstream of the compressor 4, a throttle device 12.

In both embodiments as illustrated in FIG. 1 and FIG. 2, the throttle device 12 is arranged in each Case upstream of an opening-in point 13 of the exhaust-gas recirculation line 10 into the intake line 3.

According to the invention, the throttle device 12 for reducing the inflow to the compressor may be designed as a throttle flap. Said design is adequate for this arrangement because a high degree of sealing is not required.

In an alternative embodiment, the throttle device 12 may be designed as an ancillary guide apparatus with movable blades, as a result of which a swirling inflow to the compressor is additionally possible, which has a positive effect on efficiency.

Furthermore, the throttle device 12 may be combined with a separate mixing device, such that a mixing effect is achieved by means of the supply of the exhaust gas into the intake line.

According to the invention, the exhaust-gas recirculation valve II is designed as a plate valve which regulates the exhaust-gas recirculation quantity.

Furthermore, the exhaust-gas recirculation valve 11 and the throttle device 12 may be combined to form a module 22, which leads to a reduction in production and assembly costs.

On account of the pronounced underpressure which occurs, the compressor-side arrangement of the throttle device 12 requires improved sealing between the shaft and bearing housing in order to prevent an outflow of oil from the bearing housing into the compressor housing. According to the invention, therefore, the shaft 14 of the exhaust-gas turbocharger 5 can be sealed off with respect to the bearing housing of the exhaust-gas turbocharger 5 by means of a contactless slide ring seal with aerodynamic pressure build-up.

Furthermore, the low-pressure exhaust-gas recirculation device 9 which is provided for the recirculation of the exhaust-gas quantities in the engine comprises a particle filter 15 and an exhaust-gas cooler 16. As can be seen from FIGS. 1 and 2, the high-pressure exhaust-gas recirculation device 17 comprises a high-pressure exhaust-gas recirculation line 18 which branches off from the exhaust line 7 upstream of the turbine 8 and opens into the intake line 3 downstream of the compressor 4.

An exhaust-gas recirculation valve 19 is arranged as a separate component in the high-pressure exhaust-gas recirculation line 18.

To supplement the above disclosure, reference is explicitly made to the diagrammatic illustrations of the invention in FIGS. 1 and 2.

### LIST OF REFERENCE SYMBOLS

1 Internal combustion engine

2 Intake section

2A Intake manifold

3 Intake line

4 Compressor

5 Exhaust-gas turbocharger

6 Exhaust section

6A Exhaust manifold

7 Exhaust line

8 Turbine

9 Low-pressure exhaust gas recirculation device

10 Exhaust-gas recirculation line

11 Exhaust-gas recirculation valve

12 Throttle device

13 Opening-in point

14 Shaft

15 Particle filter/Exhaust-gas recirculation filter

16 Exhaust-gas cooler

17 High-pressure exhaust-gas recirculation device

18 High-pressure exhaust-gas recirculation line

19 Exhaust-gas recirculation valve

20 Intake throttle valve

21 Particle filter

22, 23 Module

24 Charge-air cooler

1. An internal combustion engine (1),
having an intake section (2) which has an intake line (3) in which a compressor (4) of an exhaust-gas turbocharger (5) is arranged;
having an exhaust section (6) which has an exhaust line (7) in which a turbine (8) of the exhaust-gas turbocharger (5) is arranged;
having a low-pressure exhaust-gas recirculation device (9) which has an exhaust-gas recirculation line (10) which branches off from the exhaust line (7) downstream of the turbine (8) and which opens into the intake line (3) upstream of the compressor (4) and in which an exhaust-gas recirculation valve (11) is arranged, and
having a throttle device (12) arranged in the intake line (3) upstream of the compressor (4),
wherein the exhaust-gas recirculation valve (11) and the throttle device (12) are combined to form a module (22).

2. The internal combustion engine as claimed in claim 1, wherein the throttle device (12) is arranged upstream of an opening-in point (13) of the exhaust-gas recirculation line (10) into the intake line (3).

3. The internal combustion engine as claimed in claim 1, wherein the throttle device (12) is designed as a throttle flap.

4. The internal combustion engine as claimed in claim 1, wherein the throttle device (12) is designed as an ancillary guide apparatus with movable blades.

5. The internal combustion engine as claimed in claim 1, wherein the throttle device (12) is combined with a separate mixing device.

6. The internal combustion engine as claimed in claim 1, wherein the exhaust-gas recirculation valve (11) is designed as a plate valve.

7. An internal combustion engine (1),
having an intake section (2) which has an intake line (3) in which a compressor (4) of an exhaust-gas turbocharger (5) is arranged;
having an exhaust section (6) which has an exhaust line (7) in which a turbine (8) of the exhaust-gas turbocharger (5) is arranged;
having a low-pressure exhaust-gas recirculation device (9) which has an exhaust-gas recirculation line (10) which branches off from the exhaust line (7) downstream of the turbine (8) and which opens into the intake line (3) upstream of the compressor (4) and in which an exhaust-gas recirculation valve (11) is arranged,
having a mixing device for mixing exhaust gas from the exhaust gas recirculation line into the intake line, and
having a throttle device (12) arranged in the intake line (3) upstream of the compressor (4),
wherein the exhaust-gas recirculation valve (11), the mixing device and the throttle device (12) are combined to form a module (22).

8. The internal combustion engine as claimed in claim 1, wherein the shaft (14) of the exhaust-gas turbocharger (5) is sealed off with respect to the bearing housing of the exhaust-gas turbocharger (5) by means of a contactless slide ring seal.

9. The internal combustion engine as claimed in claim 1, wherein the low-pressure exhaust-gas recirculation device (9) has a particle filter (15) and an exhaust-gas cooler (16).

10. The internal combustion engine as claimed in claim 1, characterized by a high-pressure exhaust-gas recirculation device (17) which has a high-pressure exhaust-gas recirculation line (18) which branches off from the exhaust line (7) upstream of the turbine (8) and opens into the intake line (3) downstream of the compressor (4) and in which an exhaust-gas recirculation valve (19) is arranged.

11. The internal combustion engine as claimed in claim 1, wherein the throttle device (12) is an ancillary guide apparatus with movable blades.

12. The internal combustion engine as claimed in claim 7, wherein the throttle device (12) is an ancillary guide apparatus with movable blades.
